(19) United States
(12) Patent Application Publication
(10) Pub. No.: US 2023/0118160 A1
(43) Pub. Date: Apr. 20, 2023

(54) Apparatus, Device, Method, and Computer Program for Monitoring a Processing Device from a Trusted Domain

(71) Applicant: Intel Corporation, Santa Clara, CA (US)

(72) Inventor: Rajesh POORNACHANDRAN, Portland, OR (US)

(21) Appl. No.: 18/068,531

(22) Filed: Dec. 20, 2022

(51) Int. Cl. G06F 11/07; G06F 8/65; G06F 9/22

(52) U.S. Cl. CPC G06F 11/0793; G06F 8/65; G06F 11/0766; G06F 11/0709; G06F 9/223

(57) ABSTRACT

Examples of the present disclosure relate to an apparatus, device, method, and computer program for monitoring a processing device from a trusted domain. The apparatus comprises interface circuitry, machine-readable instructions, and processing circuitry to execute the machine-readable instructions to receive a request for monitoring the processing device from the trusted domain; authenticate the request; obtain information on a failure report related to a component of the processing device, with a possible failure having occurred at runtime of the processing device; and provide the information on the failure report in the trusted domain.

### BACKGROUND

Monitoring hardware devices in the field may provide valuable information for product improvement and development. Improving the quality of hardware platforms, e.g., by reducing a Defect Per Million (DPM) is a key imperative for hardware vendors and manufacturers.

In many computer systems, hardware errors are propagated as non-maskable interrupts (NMIs) or catastrophic machine check/array freeze events, causing failover or hard halts that are not acceptable for safety critical autonomous systems. Such behavior may affect system uptime, and lead to an increased DPM, reduced safety, reduced reliability and/or increased TCO (Total Cost of Ownership). Generally, such hardware behavior also might provide no basis for evaluating and evolving the ISA (Instruction Set Architecture) towards improving the silicon health and DPM metric.

While previous work has been aimed at providing fine granular telemetry on the potential latency, contention, starvation on the shared resources, it generally does not provide the capabilities to support self-healing or graceful failure handling in field in a trusted environment or in a trusted domain.

### BRIEF DESCRIPTION OF THE FIGURES

Some examples of apparatuses, devices and/or methods will be described in the following by way of example only, and with reference to the accompanying figures, in which

FIG. 1a shows a block diagram of an example of an apparatus or device for monitoring a processing device from a trusted domain, and of an example of a computer system comprising such an apparatus or device;

FIG. 1b shows a flow chart of an example of a method for monitoring a processing device from a trusted domain;

FIG. 1c shows a flow chart of another example of a method for monitoring a processing device from a trusted domain;

FIG. 1d shows a schematic diagram of a processing device;

FIG. 2 shows a schematic diagram of an example of a system architecture of an In-Field-Scan (IFS) extended microcode (XuCode) handler in a trusted domain as Tenant Driven IFS (TDIFS);

FIG. 3 shows an example of the configurational flow across components of an example; and

FIG. 4 shows an example of an operational flow of the TDIFS XuCode.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

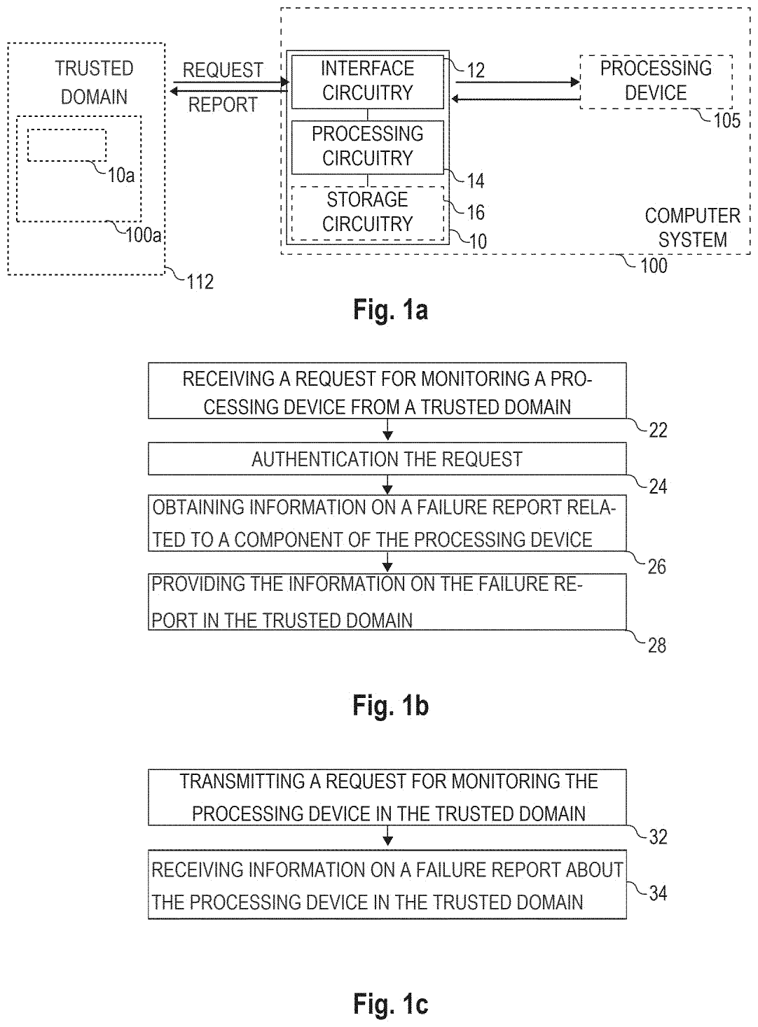

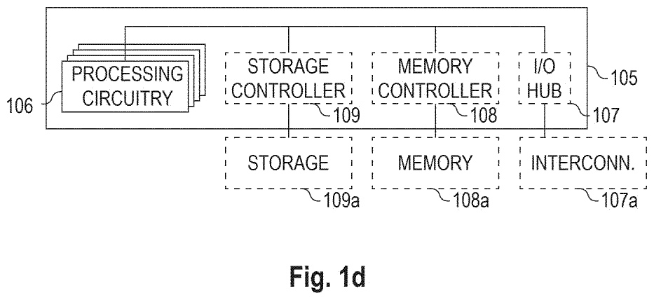

FIG. 1a shows a block diagram of an example of an apparatus 10 or device 10 for monitoring a processing device 105 from a trusted domain 112. The apparatus 10 comprises circuitry that is configured to provide the functionality of the apparatus 10. For example, the apparatus 10 of FIG. 1a comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus 10, in conjunction with the interface circuitry 12 (for exchanging information, e.g., with other components inside or outside a computer system 100 comprising the apparatus or device 10, such as the processing device 105 or a server of an operator of the computer system 100) and the storage circuitry 16 (for storing information, such as machine-readable instructions).

Likewise, the device 10 may comprise means that is/are configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processing circuitry 14, means for communicating 12 or interfacing, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is configured to receive a request for monitoring the processing device 105 from the trusted domain 112 and to authenticate the request. The processing circuitry 14 or means for processing 14 is further configured to obtain information on a failure report related to a component of the processing device 105, with a possible failure having occurred at runtime of the processing device 105. The processing circuitry 14 or means for processing 14 is configured to provide the information on the failure report in the trusted domain 112.

FIG. 1a further shows the computer system 100 comprising the apparatus 10 or device 10 and the processing device 105. For example, the apparatus 10 or device 10 may be implemented as part of a system firmware (e.g., Unified Extensible Firmware Interface, UEFI, or Basic Input/Output System, BIOS) of the computer system 100. In other words, the functionality described herein may be implemented as part of the system firmware, e.g., without requiring support from an operating system or virtual machine-manager being executed on the computer system.

FIG. 1b shows a flow chart of an example of a corresponding method for monitoring a processing device 105 from a trusted domain 112. The method comprises receiving 22 a request for monitoring the processing device from the trusted domain and authenticating 24 the request. The method further comprises obtaining 26 information on a failure report related to a component of the processing device, with a possible failure having occurred at runtime of the processing device. The method further comprises providing 28 the information on the failure report in the trusted domain.

For example, the computer system 100 (e.g., the apparatus 10 or device 10 of the computer system 100) may be configured to perform the method. In particular, the method may be performed by the system firmware of the computer system.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

In further examples the machine-readable instructions may further comprise instructions to determine information on a microcode update to be applied to the processing device 105 to remedy a failure related to the component, and to configure the processing device 105 to apply the microcode update. As will be laid out in greater details, once a failure is detected it may be healed, avoided or compensated by accordingly adapted microcode updates. Since in example such as request is issued in the trusted domain, all communication may be encoded or encrypted. Therefore, at least in some examples, the machine-readable instructions further comprise instructions to decode or decrypt the request, likewise instructions to encode or encrypt on the transmitter side.

Various examples of the proposed concept are based on the finding, that, while there are mechanisms for detecting failures of hardware components of a computer system, such as Intel® In-Field Scan (IFS), such failures often cannot be remedied automatically, as the failures are permanent and are thus likely to occur on a regular basis. Moreover, trusted domain communication of information related thereto, like requesting and reporting of IFS related information in a trusted domain (TDIFS), is not available. For example, such a trusted domain may be a Trusted Execution Environment (TEE), which may be defined by SafeGuard Extensions (SGX) and Trusted Domain eXtensions (TDX).

IFS is a feature being offered from Intel® Sapphire Rapids (4th Gen Xeon Scalable Platform). This may provide the capability to perform core tests and report failures in in-field, specifically for Silent Data Errors (SDE) that might not be detectable via existing error detection capabilities.

However, IFS might not be scalable to run within a TEE such as SGX/TDX or secure encrypted visualization (SEV) specifically in use cases like confidential computing. Also, IFS might be limited to CPU (central processing unit) cores within a socket, and not scalable to XPUs (X Processing Unit, with X being used to indicate various types processing units such as GPU (Graphics Processing Unit), FPGA (Field Programmable Gate Array) Processing Unit, etc.) at platform level with TDX IO (input/output). Public cloud tenants may have a need for a capability to run on-need basis IFS check on their VM (virtual machine) instance of choice across XPUs based on their workload sensitivity (e.g. health care data, financial trading, etc. requiring high precision and not tolerant to SDEs). Furthermore, there may be a need to provide the conduit to work with industry standard interfaces such as PCIe (Peripheral Component Interconnect Express), CXL (Compute Express Link) attach points (IO/MEM/Cache), UCIe (Universal Chiplet Interconnect Express), etc. Examples may use a “Tenant Driven In-Field-Scan (TDIFS) within Secure Trust Control Block” that addresses these challenges.

In the proposed concept, a request for an TDIFS can be generated from the transited/trusted domain and as a result, a failure report from underlying hardware components may be obtained. Moreover, a handler can be used for remedying hardware failures that have occurred at runtime of a processing device. This handler may use microcode updates to configure the processing device, in order to implement a work-around to avoid causing the failure, or to deactivate a component of the processing device, so that the processing devices can continue to be (mostly) used despite a failure being detected. This is policy configurable and may improve the reliability of the processing device and avoid fatal crashes of the computer system, which may improve the Total Cost of Ownership of the computer system. Moreover, more permanent remedies, such as a more permanent patch for remedying the failure or replacement of the processing device, may be scheduled for a maintenance window, instead of requiring instant attention from a service technician, which may reduce the effort of an operator running the computer system.

In the following, many examples will be presented, where the processing device is a Central Processing Unit (CPU) of the computer system. However, the proposed concept may be applied to any type of processing device that supports failure reporting and/or microcode or firmware updates, i.e., that supports modification of the behavior of the processing device through application of a microcode/firmware update. Accordingly, the processing device may be an XPU (X Processing Unit, with X being used to indicate various types processing units). For example, the XPU may be one of a Central Processing Unit (CPU), Graphics Processing Unit (GPU), an Artificial Intelligence (AI) accelerator, an accelerator card (such as a cryptocurrency mining accelerator) and offloading circuitry.

Depending on the processing device being used, the component of the processing device, to which the failure relates may be different, too. For example, if the processing device is a CPU, the component may be a processing circuit of the CPU, such as an ALU (Arithmetic Logic Unit), a memory, such as a register, a cache, a bus, or a controller (such as an Input/Output (I/O) controller, a memory controller, or a storage controller) that is part of the CPU. In the latter case, the CPU may also be considered a System-on-Chip (SoC), having one or more controllers integrated in the CPU Similarly, if the processing device is a GPU, AI accelerator, accelerator card or offloading circuitry, the component may be a processing circuit, such as an execution unit, a memory, a register, a cache, a bus, or a controller (such as an I/O controller or a memory controller) of the processing device. In the present disclosure, failures are being remedied that relate to the respective component of the processing device. Therefore, in many cases, the respective failure may occur in the component of the processing device. However, as will become evident in the following, in some cases, the failures may occur outside the processing device, e.g., in a memory, in a storage circuitry, or while communicating via an interface. In this case, the processing device may be used to remedy failures occurring outside the processing device.

In various examples, the process starts with receiving the request for monitoring the processing device in the trusted domain. Such a request may be transmitted by another apparatus 10a for monitoring the processing device 105 from an application in the trusted domain 112. Such an apparatus 10a may also comprise interface circuitry, machine-readable instructions, and processing circuitry to execute the machine-readable instructions as described above. The machine-readable instructions are configured to transmit a request for monitoring the processing device 105 in the trusted domain 112 and to receive information on a failure report about the processing device 105 in the trusted domain 112. Hence, such an apparatus 10 may be part of another computer system 100a on the application side, which can be part of the trusted domain 112 as illustrated by FIG. 1a. The apparatus 10a and computer system 100a may comprise similar components as have been described above for apparatus 10 and computer system 100.

FIG. 1c shows a flow chart of another example of a method for monitoring a processing device 105 from a trusted domain 112. The method comprises transmitting 32 a request for monitoring the processing device 105 in the trusted domain 112 and receiving 34 information on a failure report about the processing device 105 in the trusted domain 112. Transmitting and receiving in the trusted domain may include according en- and decoding of the communicated information, encryption and decryption, respectively.

In examples, the processing circuitry may obtain (e.g., receive, be notified of) the information on the failure (report) related to the component of the processing device 105. In general, there are various potential sources of the information on the failure. For example, the processing device (or the component thereof) may detect a failure occurring (a failure occurring within the component, or a failure occurring outside the component and having an effect on the component) and notify the processing circuitry of the failure having occurred. For example, the processing circuitry may be configured to handle a non-maskable interrupt (NMI) being raised by the processing device (or the component thereof), with the NMI comprising the information on the failure (or an address of memory comprising the information on the failure).

Alternatively, an in-field hardware scanning mechanism, such as the aforementioned Intel® In-Field Scan, may be used to provide the information on the failure to the processing circuitry. In other words, the processing circuitry may be configured to obtain the information on the failure report related to the component of the processing device from a (trusted domain) in-field scan circuitry of the processing device. Accordingly, as shown in FIG. 1b, the method may comprise obtaining 110 the information on the failure report related to the component of the processing device from an in-field scan circuitry of the processing device. As a result, the information on the failure related to the component may be based on a failure related to the component occurring in the field (i.e., after manufacturing, during runtime of the processing device (at the customer)). The in-field scan circuitry may scan the hardware of the processing device for errors/failures and report them as information on the failure to the processing circuitry. For example, the (trusted domain) in-field scan circuitry may raise an interrupt to notify the processing circuitry about the information on the failure. In other words, the processing circuitry may be configured to obtain the information on the failure (report) related to the component after an interrupt being raised (e.g., in response to an interrupt being raised, by handling the interrupt) by the in-field scan circuitry of the processing device.

Accordingly, as shown in FIG. 1b, the method may comprise obtaining 110 the information on the failure (report) related to the component after an interrupt being raised by an in-field scan circuitry of the processing device. In both cases, the information on the failure may be obtained by providing an interrupt handler for handling interrupts related to hardware failures. In other words, the processing circuitry may be configured to provide an interrupt handler (for receiving/handling the information on the failure). However, other means of obtaining such information may be used as well. For example, the processing circuitry may be configured to read out the information on the failure from a register or memory region being used to log hardware failures. Alternatively, the processing circuitry may be configured to provide an Application Programming Interface (API) for receiving the information on the failure.

In most other systems, failure detection and remediation in processing devices is limited to the manufacturing process (where binning is used to sort processing devices according to their capabilities) or to scenarios, where customer-specific microcode updates are rolled out, after a formal and usually month-long fixing process, to the processing devices of a fleet of computer systems comprising the respective device (with the processing devices being taken offline between identification of the failure and application of the fixes). In contrast to these approaches, examples may enable an in-field process (i.e., after the manufacturing process, while the respective processing devices are being used by the customers) which does not require taking the respective computer systems offline. Instead, the failures may be remedied during the runtime of the respective processing devices, by dynamically applying microcode or firmware updates securely to the processing device.

For this purpose, the information on the failure is processed, by the processing circuitry, to determine the type of failure having occurred, and the component of the processing device being affected. For example, if the failure occurs within the processing device, the information on the failure related to the component may comprise information on a circuit-level failure affecting the component. If the failure occurs outside the processing device, the information on the failure related to the component may comprise details on how the component is being affected (e.g., information on hardware, such as memory, storage circuitry or an interconnect being controlled by the respective controller of the processing device). Using such information, the processing circuitry may select the remedy to apply.

In various examples of the proposed concept, the determination of the microcode or firmware update to apply, may be based on a mapping between failures and microcode updates to perform. In other words, the processing circuitry may be configured to determine the information on the microcode update to be applied to the processing device to remedy the failure related to the component based on a mapping between failures and microcode updates. Accordingly, the method may comprise determining the information on the microcode update to be applied to the processing device to remedy the failure related to the component based on a mapping between failures and microcode updates. For example, the storage circuitry 16 may comprise the mapping, e.g., as a look-up table or database. The processing circuitry may be configured to identify or categorize the failure and select the corresponding microcode update based on the mapping.

In many scenarios, failures of hardware devices may occur over time, as aging effects affect the performance of the respective circuitry, in particular for circuitry being used constantly. Moreover, some failures occur when multiple different components are used concurrently or when other conditions are met, such as the use of Simultaneous Multithreading (SMT). In effect, remedies to such failures may not be known at shipping of the computer system, as the failures themselves are unknown to the manufacturer of the computer system. Therefore, the aforementioned mapping may be updated and/or extended over time, to account for newly discovered types of failures for which remedies have been designed over the lifetime of the processing device. For example, the processing circuitry may be configured to update the mapping between the failures and microcode updates. Accordingly, the method may comprise updating the mapping between the failures and microcode updates. Another example wherein the failure is out of the manufacturer control is in terms of interoperability scenarios of various XPUs in a real-world—e.g., CPU working with a SmartNIC (Network Interface Controller) for communication and with a GPU for some AI (Artificial Intelligence) inferencing. A hardware (HW) manufacturer cannot envision all the possible permutations in terms of variety of XPUs a given XPU might work with in a field.

In the previous examples, the mapping between the failures and the microcode updates has been said to be provided by the manufacturer of the processing device. However, in some cases, different remedies may be available to remedy a failure. For example, a choice may be made between removing support for a part of the ISA and emulating this part of the ISA. Furthermore, a choice may be made between lowering an operating frequency of a component and excluding the component from concurrent use due to SMT. While these choices may be made by the manufacturer, in many scenarios, they may also be made by an operator of the respective computer system (i.e., the company using the computer system, which may be a Customer Service Provider, CSP). Accordingly, the mapping may be an operator-defined policy supplied by an operator of a computer system comprising the processing device. For example, the operator-defined policy may be applied to a fleet of computer systems being operated by the operator.

Once the microcode update has been selected, it may be applied to the processing device. In the following, two different types of microcode updates will be discussed, which may be used to enable different types of remedies.

In general, the microcode being run by a processing device determines at least some of the behavior of the processing device. For example, in CPUs, the control unit of the CPU is generally responsible for translating machine-code instructions defined by a computer program to circuit-level micro-operations (uOps). However, in case this translation proves, after shipping, to produce errors, some of the machine-code instructions can be handled via microcode, instead of being handled by the hard-coded (and therefore more efficient control unit). The functionality of the microcode-based translation is the same—the machine-code instructions are translated into corresponding micro-operations. However, the microcode can be updated after the respective processing device has been shipped, at runtime.

The proposed concept uses this microcode mechanism to remedy the detected failure. The processing circuitry is configured to configure the processing device to apply a microcode update that is suitable for remedying the failure that has been identified. For example, the microcode being run by the processing device may be extended to add one or more instructions (affecting the component) to be handled via microcode, with corresponding instructions on how the respective instruction(s) are to be handled (e.g., by emulating the instructions, or by using different circuitry). Alternatively, the microcode update may be configured to disable the component (e.g., by handling all instructions that relate to the component or by removing these instructions from the ISA). Accordingly, the microcode update may affect the instructions being exposed by the instruction set architecture of the processing device. In some cases, the use of the component may only be disabled in certain scenarios that are known to put a high strain on the respective component, such as SMT (Simultaneous Multithreading). Accordingly, the microcode update may affect a shared use of one or more components of the processing device in simultaneous multithreading. Alternatively, or additionally, the microcode update may change an operating frequency of the respective component. In other words, the microcode update may affect an operating frequency of the component of the processing device (e.g., via the Baseboard Management Controller). In this context, the term “microcode update” may refer to any update of the respective processing device that affects the configuration of the processing device, including operating frequencies and activation status of its components.

A main remedy being used in the proposed concept, however, seeks to avoid partially or entirely disabling the component, by specifying, by microcode, a workaround. Therefore, the microcode update may affect a use of one or more components of the processing device for performing an instruction being exposed by an instruction set architecture of the processing device. In particular, the microcode update may affect which components are used to handle the instruction being performed. For example, the microcode update may cause the component not to be used or to be used less frequently or stall for configured cycles, by translating the machine-code such, that the resulting microoperations make less frequent use or no use of the component. Instead, the microcode update may define an emulation of the instruction being performed. In effect, the microcode update may comprise instructions to emulate a functionality originally provided by the component. In some cases, such an emulation may be achieved by just using another processing circuitry (e.g., ALU or execution unit) of the processing device.

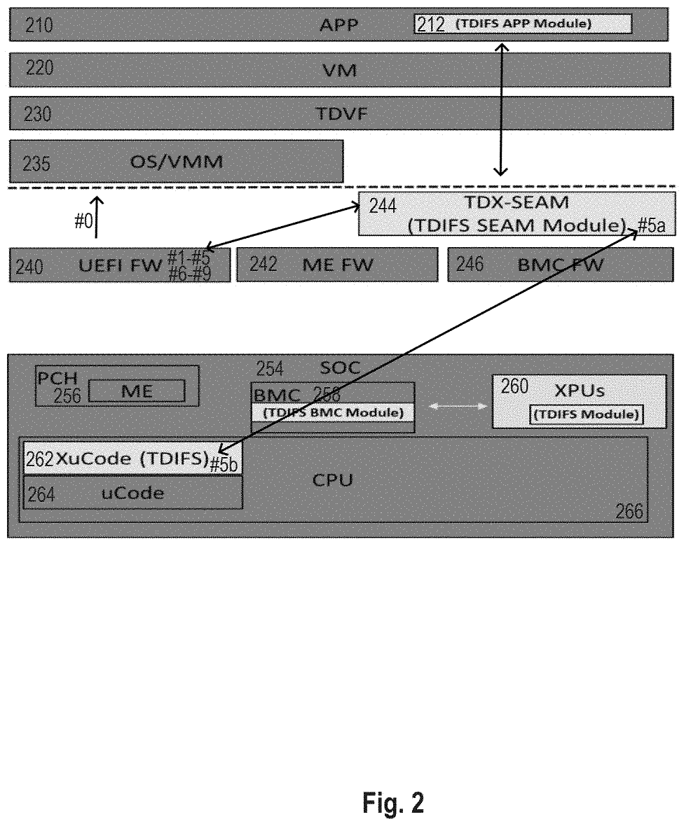

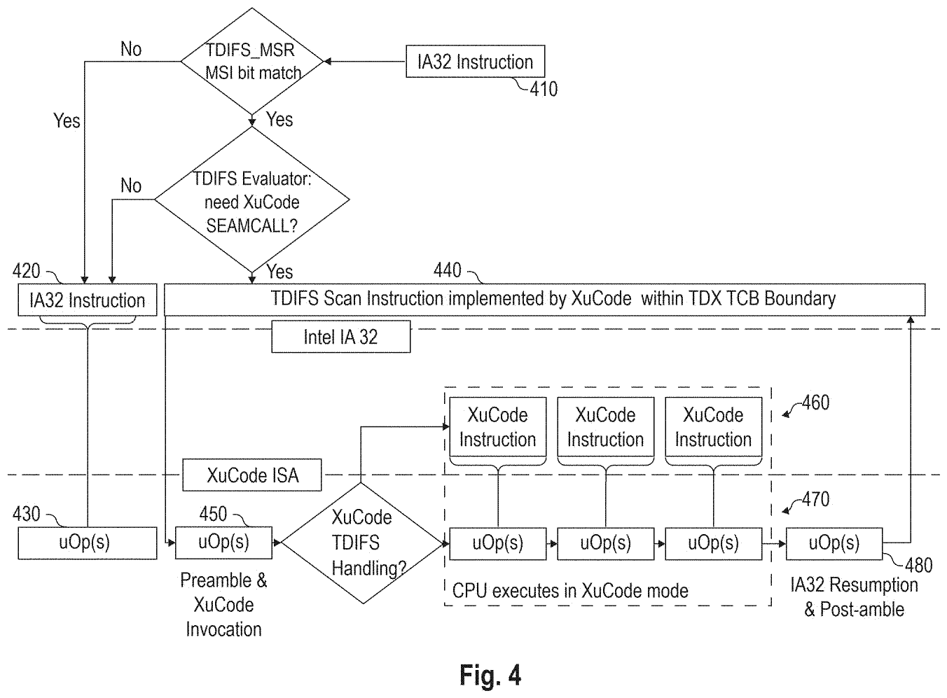

In some cases, however, emulation may be more complex. In this case, use of an extended microcode, such as Intel® XuCode, may be made. Accordingly, the microcode update may be or comprise a XuCode update. In connection with FIGS. 2 to 4, various examples are given on how XuCode can be used for this purpose. In particular, as shown in FIG. 4., XuCode may be used to handle instructions to be emulated, with the XuCode being used to generate the corresponding microinstructions 450 for invoking XuCode handling, microinstructions 470 for performing the XuCode instructions 460, and microinstructions 480 for resuming IA32 handling. Other instructions that do not require to be emulated, e.g., as they are not affected by the microcode update or as a simple microcode update suffices for these instructions, may bypass this XuCode handler. For example, the microcode update may enable and configure the XuCode handler.

As has been outlined before, in some cases, the failure may occur outside the processing device, but may nonetheless affect the component. In particular, the failure may occur in hardware components that are controlled by the processing device 105, such as a communication interconnect (such as Intel® Quick Path Interconnect, QPI, or Peripheral Component Interconnect express, PCIe), a memory (e.g., High Bandwidth Memory, HBM, on-package memory or a DIMM, Dual-Inline-Memory-Module) or storage circuitry (such as a solid-state drive). The processing device may comprise one or more controllers for controlling these hardware components. FIG. 1d shows a schematic diagram of a processing device, comprising processing circuitry 106, an (optional) I/O hub (for controlling the communication interconnect 107a), an (optional) memory controller 108 for controlling a memory 108a, and an (optional) storage controller 109 for controlling the storage circuitry 109a.

These components may be configurable by microcode updates as well, such that machine-code instructions relating to the respective controller (or hardware device they represent) are handled by the microcode-based mechanism as well. For example, the microcode update may relate to an input/output controller 107 of the processing device, affecting the use of at least a part of an interface being coupled to the processing device. For example, if the information on the failure indicates, that a part of the interconnect, e.g., a PCIe lane, is correlated with a high bit error rate, the microcode update may be configured to operate the interconnect such, that the particular lane is not being used, e.g., by reconfiguring a PCIe x8 connection as PCIe x4 connection. In another example, the microcode update may relate to a memory controller 108 of the processing device, affecting the use of at least a portion of memory included in a computer system comprising the processing device. For example, a so-called device of the memory (of a DIMM) may be faulty, resulting in correctable or uncorrectable error.

The microcode update may be configured to redirect memory instructions relating to the device such, that a spare device is used instead. Similarly, the microcode update may relate to a storage controller 109 of the processing device, affecting the use of at least a portion of storage circuitry included in a computer system comprising the processing device. For example, a portion of the storage circuitry may be faulty. The microcode update may be configured to redirect storage instructions relating to the faulty portion such, that spare storage capacity is used instead.

In the examples provided above, the microcode update is selected based on a failure that has occurred within this particular computer system, at runtime of the computer system. However, in some cases, an operator of a large fleet of similar machines may notice an occurrence of the same failure across the fleet, with the failure occurring in many but not all machines. As a preventive measure, microcode updates that remedy this failure may be applied to the fleet of machines, regardless of whether the failure has already occurred in the particular computer system. In other words, the processing circuitry may be configured to obtain second information on a failure of a component of the processing device occurring in other computer systems (being similar to the computer system 100/100a housing the apparatus 10/10a). Accordingly, the method may comprise obtaining second information on a failure of a component of the processing device occurring in other computer systems. For example, the second information may be operator-specified second information supplied by an operator of a computer system comprising the processing device, e.g., by the operator operating a fleet of similar computer systems.

Accordingly, the second information may be based on failures of one or more components of the processing device having occurred in a plurality of (similar) computer systems (i.e., the fleet from computer systems) being operated by the operator. For example, the second information may be implemented similar to the information on the failure, indicating a failure that has occurred in the processing device of another computer system. For example, the second information may be obtained (e.g., received, downloaded) from a server of the operator of the computer system (with the operator being separate from the manufacturer of the processing device and/or computer system). In general, the second information may be treated similar to the information on the failure. For example, the processing circuitry may be configured to determine information on a microcode update to be applied to the processing device to remedy the failure related to the component included in the second information, and to configure the processing device to apply the microcode update. Accordingly, the method may comprise determining information on a microcode update to be applied to the processing device to remedy the failure related to the component included in the second information and configuring the processing device to apply the microcode update. For example, the same mapping may be used to determine the information on the microcode update that is also used for the information on the failure.

The interface circuitry 12 or means for communicating 12 (comprised in the apparatus 10/10a) may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 (comprised in the apparatus 10/10a) may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 (optionally comprised in the apparatus 10/10a) may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100/100a may be a workstation computer system (e.g., a workstation computer system being used for scientific computation) or a server computer system, i.e., a computer system being used to serve functionality, such as the computer program, to one or client computers.

More details and aspects of the apparatus 10/10a, device 10/10a, method, computer program and computer system 100/100a are mentioned in connection with the proposed concept, or one or more examples described above or below (e.g., FIGS. 2 to 4). The apparatus 10/10a, device 10/10a, method, computer program and computer system 100/100a may comprise one or more additional optional features corresponding to one or more aspects of the proposed concept, or one or more examples described above or below.

Various examples of the present disclosure relate to a concept related to autonomous harvest (in the FuSA (Functional Safety) Domain). The term autonomous harvesting refers to automatically collecting information about failures of hardware devices from a trusted domain. Such a collection mechanism may be supported by a BMC (Baseboard Management Controller), which may collect information on failures from one or a plurality of hardware devices. The information may be collected by means of failure reports from one or more hardware devices, for example, from a fleet of hardware devices and provided to a fleet administrator/manager. The proposed concept may also provide a mechanism for an efficient CPU/XPU In-Field Scan (IFS) from the trusted domain, with the mechanism potentially being suitable for remediating defects using microcode updates (e.g., using XuCode, in the following denoted IFSXu for this specific implementation) for improved reliability and safety.

Another aspect of the proposed concept relates to exposing the capability of trusted domain or Tenant Driven In-Field-Scan (TDIFS) via XuCode for upcoming new ISAs (Instruction Set Architectures) or new exception handling capabilities from the trusted domain. This may allow manufacturers and partners to evaluate new capabilities for joint co-engineering/research on how potential new techniques work in real-world deployment challenges including functionality, safety, security, and reliability.

FIG. 2 shows a schematic diagram of an example of a system architecture for TDIFS with XuCode. FIG. 2 shows the layers “applications” 210 with a TDIFS application Module 212, “virtual machines” (VMs) 220, “TDX virtual firmware” (TDVF) 230, and the Operating System (OS)/Virtual Machine Manager (VMM) 235, which may communicate with the system firmware (e.g., with the UEFI (Unified Extensible Firmware Interface) or BIOS (Basic Input/Output System)) 240. In addition, FIG. 2 shows management engine firmware (ME FW) 242, TDX SEAM (Secure Arbitration Mode, TDIFS SEAM Module) 244, and a Baseboard Management Controller firm ware (BMC FW) 246.

The TDIFS-App Module 212 is the application TDIFS module that allows SGX/TDX VMs to perform IFS based on provisioned policies (During Idle Cycle Implicit Mode or On-Demand Explicit Mode). The TDIFS-SEAM Module 244 manages the TD specific IFS Meta Data structure encrypted with the TD private key (new data structure introduced by examples to keep track of TDIFS-App Initiated/Configured IFS). The above machine-readable instructions or method may further comprise instructions to forward information on the request to a secure arbitration module 244 for processing the request based on microcode related to the request.

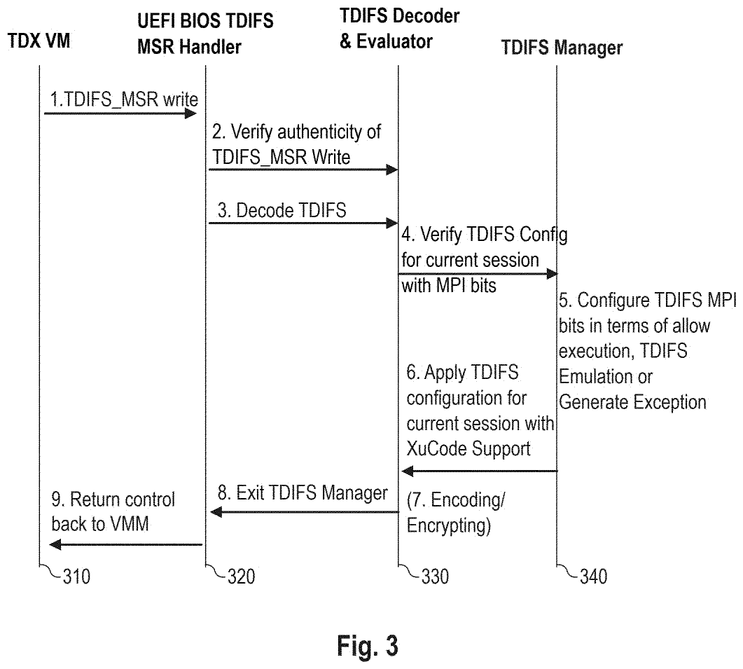

The system firmware may be extended with a microcode update manager (TDIFS manager 340 in FIG. 3), which may configure the XuCode 262 (an implementation of extended microcode) or microcode 264 of the SoC (System-on-Chip) 254. For example, the microcode update manager may correspond to the apparatus 10/10a or device 10/10a shown in connection with FIG. 1a.

The microcode update manager (TDIFS manager 340 in FIG. 3) may comprise an (TD-)IFSXu Manager with an microoperation (uOp) surplus mapper, which may be used to generate a required new IFS for execution, an IFS Evaluator & Dispatcher with a mile-marker and an IFS Decoder. The microcode update manager may further comprise a XuCode Error Manager with an (TD-) IFS BMC (Baseboard Management Controller) Agent, an IFS Error Remediator, and an IFS Error Interrupt Handler.

As further illustrated, in the system on a chip (SOC) 254 there is a Platform Controller Hub (PCH) 256 with a management engine (ME) and a Baseboard Management Controller (BMC) 258 with a TDIFS BMC Module. The TDIFS-BMC Module provides the capability to aggregate all the encrypted TDIFS Meta Data and associated IFS report across variety of XPUs 260 (having their own TDIFS modules) on the platform via out-of-band dedicated interconnect interface such as PECI (Platform Environment Control Interface). This can report out the entire platform IFS (self-triggered or TD VM initiated) to a data center fleet manager. The CPU 266 has a XuCode (TDIFS) 262 and uCode 264. The TDIFS XuCode Module 262 is an augment platform XuCode to support the TDIFS capability, wherein during TEE Entry and Exit, this module looks upon the TDIFS-App Policy provisioning and kick-off/stop TDIFS scan. For example, during SEAMCALL, the XuCode can check if TDIFS support is enabled and take configured actions to kick-off the TDIS on-demand or trickle mode idle cycle version across one or more XPU of choice (by leveraging TDIFS XPU Module within each XPU—both Intel and 3rd party). Prior to SEAMEXIT, this module would ensure to encrypt the IFS Report data within the TD Control structure encrypted with TD private key.

In an example, a Tenant-Driven In-Field-Scan within Secure Trust Control Block (TDIFS) may involve the TDIFS APP Module 212, the TDX-SEAM 244, the UEFI FW 240, the XuCode (TDIFS) 262, the TDIFS BMC module 258 and the TDIFS module 260 as key components.

For example, with respect to the SoC 254, the proposed TDIFSXu concept may involve exposure of TDIFS_MGR (In-Field Scan Manager) as an MSR (Manager Status Register) for the VMM/OS 235 to configure specific an ISA behavior (e.g., VNNI, Vector Neural Network Instruction). For example, Intel's extended microcode implementation XuCode provides the capability for the CPU to emulate specific ISA behavior. For example, based on the requirement/situation, a portion of the XuCode to be hardened and made proprietary—to mitigate any possibility of safety violations/exceptions. However, a portion of the XuCode can be extended for OEM (Original Equipment Manufacturers)/ISVs (Independent Software Vendors) to enable customizations as needed. This may also provide operators/customers to provide the flexibility to capture any exceptions for specific ISA behavior and complement existing in-field scan errors. These findings can be proliferated to improve the quality of the platform.

The microcode update manager may be part of the system firmware (e.g., UEFI/BIOS) 240 and may handle the IFS Message Signaled Interrupts (IFS_MSI) generated by the IFS_MSR trigger and handle the configuration flow shown in FIG. 3.

The microcode TDIFS Manager 340 may handle most of the operational flow of TDIFSXu (FIG. 4), wherein it may evaluate the current IFS under consideration to be handled under following categories: (1) Direct pass-through mode, wherein IFS execution happens similar to today if allowed as per IFS_MGR MSI bits configured in configuration flow (as shown in FIG. 3), (2) IFS Emulation, wherein new IFS capabilities can be emulated via XuCode or Surplus uOps mapping (as shown in FIG. 4), or (3) IFS Trap/Exception Handling, wherein based on the MPI (Message Passing Interface) bit masks configured, execution may be prevented and a configurable policy based action may be taken, which may include generating an exception using XuCode. FIG. 3 shows an example of the configurational flow across components of the proposed concept highlighted in FIG. 2. FIG. 4 shows an example of an operational flow of the TDIFSXu 260.

In the following, an example of a configuration flow for the proposed concept is given, which is illustrated in FIG. 3. Before the flow begins, the UEFI FW 240 as shown in FIG. 2 may expose an MSR configuration to VMM/Applications to indicate TDIFS capabilities (Step #0).

At 1., the host TDX VM (Trusted Domain Virtual Machine) 310 requiring a specific ISA prevention or emulation may request entry into the TDIFS Manager 340 by performing a write to the TDIFS Manager Status Register (TDIFS_MSR), triggering the entry. At 2., the UEFI/BIOS TDIFS MSR Handler 320 may handle the TDIFS Message Signaled Interrupts (TDIFS_MSI) generated by the TDIFS_MSR trigger. The UEFI BIOS TDIFS Handler 320 may validate the following items: (a) TDIFS_MGR matches the CPU in the platform, (b) TDIFS_MGR has a valid Header, Loader version & checksum, and (c) TDIFS_MGR authenticity & signature check pass.

At 3., based on the MSI bits set by host TDX VM 310, TDIFS_MGR 320 may decode and determine if the TDIFS should be allowed to execute, or should the TDIFS be emulated or generate an exception or block the TDIFS execution or take other configurable policy-based actions. At 4., the TDIFS Decoder & Evaluator 330 may verify the TDIFS configuration for the current session using the MPI (or MSI) bits. At 5., based on 4., MSI bits, the TDIFS_MGR 340 may take policy-based actions including generating new micro-Ops (and thus updating the microcode) using a surplus mapper for execution. Post configuration, the TDIFS_MGR may perform a host-MSR write to trigger unload of TDIFS_MGR Apps and TDIFS_MGR itself. Steps #2-5 in FIGS. 2/3 happen in UEFI FW 240. A Step #5a (not shown in FIG. 3) may happen in TDX-SEAM Module 244, (wherein the TDX-SEAM Module communicates with the XuCode TDIFS module 262 to check on the capability support being requested by application). A Step #5b (not shown in FIG. 3) may happen in the XuCode TDIFS module 262 to check on the capability support being requested by the application and respond to the TDX-SEAM module's 244 request.

The following steps #6-#9 in FIGS. 2/3 then take place at the UEFI FW 240. At 6., the TDIFS_MGR may apply the TDIFS configuration for the current session with XuCode support. At a potential step 7 the encoding or encryption may take place. At 8., the flow may exit the TDIFS manager. At 9., the UEFI BIOS may return control back to host/TDX VM. The machine-readable instructions may further comprise instructions to receive information on the failure report from the secure arbitration module 244.

In further examples, any XPU may be monitored. XPU may refer to a generalization/scalability to any ‘X’ processing unit beyond CPU of today (CPU, GPU, FPGA (Field Programmable Gate Array) PU, etc.). The BMC may aggregate (TD) IFS info asked by the application across one or many XPUs and may send an aggregated fingerprint to an application or fleet manger, cloud administrator, respectively. The BMC may aggregate fingerprint of IFS across all XPUs in a specific platform via OOB (Out-Of-Band) channel from XPUs and may send it to a cloud administrator via an OOB secure channel. The cloud administrator may aggregate all the fingerprints from 1-N platforms in a fleet of servers in a data center for cross-co-relation.

Hence, the machine-readable instructions, may further include instructions to receive a request for monitoring a plurality of processing devices from the trusted domain, to authenticate the request, to obtain information on a plurality of failure reports related to a plurality of components of the plurality of processing devices, with a possible failure having occurred at runtime of the plurality of processing devices, and to provide the information on the plurality of failure reports in the trusted domain. The above methods may be contemplated by the according method steps.

Hence, the above-described apparatuses, devices or methods may further comprise (machine-readable instructions) to transmit a request for monitoring a plurality of processing devices in the trusted domain and to receive information on a plurality of failure reports about the plurality of processing devices in the trusted domain.

FIG. 4 shows an example of the operational flow. Based on the configurational behavior for specific TDIFS under consideration, the TDIFSXu, which may be implemented by an aspect of the apparatus 10/10a or device 10/10a of FIG. 1a, may perform the following. When an IA32 (Intel® Architecture 32-bit) instruction 410 is called, the IFSXu may check whether the IA32 instructions has an TDIFS_MSR MSI bit match (e.g., whether the IA32 instruction is part of a list of instructions/requests for which a microcode update exists). If not, the IA32 instruction may be executed unmodified, or if the instruction is executed based on modified microcode, but does not require XuCode TDIFSXu support, the IA32 Instruction 420 is mapped directly to corresponding microoperation(s) 430 and executed.

In other words, the TDIFSXu may perform direct pass-through of execution of TDIFS via the corresponding microoperations. If the IA32 has an TDIFS_MSR MSI bit match and needs XuCode TDIFSXu support, the IA32 instruction 440 may be implemented using XuCode (for exception handling and healing) or a TDIFS scan instruction implemented by XuCode within TCB (trust computing base) boundary. For example, if the TDIFS needs to be trapped, TDIFSXu may go through XuCode appropriately to take the configured policy-based action via an interface to BMC (Baseboard Management Controller) where it may be remotely managed with appropriate telemetry/configurable policies. There, it may be translated into micro-operations, including microoperation(s) 450 for preamble and XuCode invocation, micro-operations 470, which are derived from XuCode instructions 460 (i.e., which implement the emulation), and microoperation(s) 480 for IA32 resumption and post-amble.

When signals from peripheral devices, such as PCI (Peripheral Component Interface) or PCIe (PCI express) signals arrive, the signals may be provided first to XuCode before sending an NMI/interrupt to the hypervisor OS, as XuCode may be used to remediate some class of issues (such as parity errors) to increase knowledge on errors seen by third-party telemetry. The DPM may be reduced by fixing things in the SoC (System-on-Chip), e.g., by issuing microcode updates that support the respective controllers. For example, Single bit error (SBE) from integrated HBM or other memories on the SOC can migrate memory mapping (using spare memory for sparing purposes) to increase the reliability.

The proposed concept may provide the capability to monitor processing devices from a trusted domain, detect errors and recovery in-field (either full recovery or operate in degraded functionality), i.e., real-time resiliency in field at scale deployment in data center without off lining system. The proposed concept may reduce the Defect Per Million by reducing catastrophic errors in-field by letting operators use the system with desired or tolerable minimal functionality. The proposed concept may also support ISA uniformity (when deploying new kernels) for early evaluation on N−1 platforms. The proposed concept may also help in protecting critical portions with proprietary XuCode and also, provide flexibility with additional/extended portions for customers/OEMs to enable customizations. It may enable customers to trap and generate custom exception handling for specific ISA behavior programmable via MSR. It may provide the capability to allow the emulation of new ISA on N−1 CPUs (Central Processing Units) or to test wafers for N+1 on current generation of SKUs (stock keeping unit). It may also enable the generation of additional stock keeping units, by socializing upcoming error handling for newer ISAs, future proof DPM with early fail-fast approach using N−1 generation.

The following data structures illustrate an example of a TDIFS Meta Data structure, associated Report data structure, along with the TDIFS Scan Status indicator MSR for TD VM to access on the execution status. Encrypted report data would be available for a platform BMC module from across one or more XPUs via an OOB interconnect that can be securely exposed, for example, to a fleet manager.

| struct TDIFS_Metadata { | |
|---|---|
| u32 ver; | |
| u32 blob_revision; | |
| u32 date; | |
| u32 processor_sig; //XPU | |
| u32 check_sum; | |
| u32 loader_rev; | |
| u32 processor_flags; //XPU | |
| u32 metadata_size; | |
| u32 total_size; | |
| u64 reserved; | |
| }; | |
| Struct TDIFS_Report_Data { | |
| UINT32 Report_ID, | |
| UINT32 Scan_duration, | |
| UINT32 Scan_config_bit_map, | |
| UINT32 Scan_status, | |
| UINT32 Auth_ID, | |
| BOOL Auth_Status, | |
| UINT32 CLK_PWR_GATING, | |
| UINT32 ReservedFields[ ] | |
| }; | |
| /* MSR_TDIFS_SCAN_HASHES_STATUS bit fields */ | |
| union ifs_scan_hashes_status { | |
| u64 | data; |

struct {

| | |
|---|---|
| u32 chunk_size | :16; |
| u32 num_chunks | :8; |
| u32 rsvd1 | :8; |
| u32 error_code | :8; |
| u32 rsvd2 | :11; |
| u32 max_core_limit | :12; |
| u32 valid | :1; |

| }; | |
|---|---|
| }; | |
| /* MSR_TDIFS_CHUNKS_AUTH_STATUS bit fields */ | |
| union ifs_chunks_auth_status { | |
| u64 | data; |

struct {

| | |
|---|---|
| u32 valid_chunks | :8; |
| u32 total_chunks | :8; |
| u32 rsvd1 | :16; |
| u32 error_code | :8; |
| u32 rsvd2 | :24; |

};
};

Examples may provide a capability to configure, run and report IFS scan within a TCB TEE trust boundary across one or more XPUs. This provides the capability for public cloud tenants to perform idle cycle or on-demand IFS scans across one or more XPUs in a platform beyond just a core via PCIe/CXL/UCIe interconnects dynamically, and retrieve the report as an encrypted block with BMC support for a fleet manager or to guest TD VMs with a private key. Examples may provide a concept to mitigate design/manufacturing limitations via software innovation that is scalable to a Datacenter Of Future (DCoF) based XPU model, future-proofing.

Implementations of the proposed concept may build upon the In-Field-Scan (IFS) capability supported by some Intel® Xeon® processors. IFS is a technique that can detect hardware failures by running tests. However, the initial implementation of IFS cannot remediate the failure. The proposed concept may combine IFS with remediation handlers. This may allow extending IFS in the trusted domain to go beyond just detection and reporting flaws to the manufacturer but instead reduce the Total Cost of Ownership (TCO) by having the handlers ensure that the CPU can still operate for the customer (i.e., self-healing). Handlers can include, but are not limited, to Intel's extended microcode (XuCode), core microcode, SoC microcode, etc. In other systems, if IFS detects a bug or error, the IFS report is sent to the manufacturer and the CPU is taken offline. Then, the manufacturer develops (e.g., curates) a fix and creates a patch for patching the microcode, and delivers the patch to the customer, which applies the patch and brings the CPU back online.

In the proposed concept, if the IFS detects a bug or error, the IFS may invoke the remediation handler, which remediates the flaw, e.g., by emulating the functionality, working around the affected component, or disabling the affected component. In addition, the error may also be reported to the manufacturer, so the manufacturer can create a formal fix to patch the CPU. In the meantime, the CPU stays online. The formal fix can be applied during a normal maintenance window, which may avoid unexpected downtime.

Thus, while, in other systems, microcode patches for fixes are issued as well, it is an offline, transactional process, which may take several months and requires taking nodes offline in the customer's server farm. The proposed concept may however allow, for on-line, real-time self-fixing. Moreover, as the industry tends towards extending the life of existing silicon (e.g., sustain fleet for longer duration), having the ability to self-heal aging processing devices may provide additional benefit to the customers. This can also be combined with existing servicing flows like seamless updates.

In addition, the proposed concept may be used to de-feature or degrade processing devices, if necessary, e.g., to disable components found to be faulty. In this case, the enhanced IFS may report the omission of that feature in CPUID (an auxiliary processor instruction exposing details and capabilities of the processor to the system firmware or operating system). This may also enable post-ship ‘binning’, since today this type of test/sort/binning only can be done during manufacturing.

To summarize, various examples of the proposed concept may relate to the following aspects: Extending the in-field scan detection to the trusted domain and optionally to invoke a handler. For example, the handler may emulate a capability, or the handler may remove (e.g., elide) a capability and update CPUID correspondingly. Potential fix telemetry may be reported back to the manufacturer so the manufacturer can develop a robust fix. Moreover, the telemetry can be blinded somewhat or made concise for the handler generating long-term statistics/machine learning heuristics.

More details and aspects of the IFSXu concept in the trusted domain are mentioned in connection with the proposed concept or one or more examples described above or below (e.g., FIG. 1a to 1d). The IFSXu concept may comprise one or more additional optional features corresponding to one or more aspects of the proposed concept, or one or more examples described above or below.

In the following, some examples of the proposed concept are presented:

An example (e.g., example 1) relates to an apparatus (10; 10a) for monitoring a processing device (105) from a trusted domain (112), the apparatus (10; 10a) comprising interface circuitry (12), machine-readable instructions, and processing circuitry (14) to execute the machine-readable instructions to receive a request for monitoring the processing device (105) from the trusted domain (112); authenticate the request; obtain information on a failure report related to a component of the processing device (105), with a possible failure having occurred at runtime of the processing device (105); and provide the information on the failure report in the trusted domain (112).

Another example (e.g., example 2) relates to a previously described example (e.g., example 1) or to any of the examples described herein, wherein the machine-readable instructions further comprise instructions to determine information on a microcode update to be applied to the processing device (105) to remedy a failure related to the component, and to configure the processing device (105) to apply the microcode update.

Another example (e.g., example 3) relates to a previously described example (e.g., one of the examples 1 or 2) or to any of the examples described herein, wherein the machine-readable instructions further comprise instructions to decode the request.

Another example (e.g., example 4) relates to a previously described example (e.g., one of the examples 1 to 3) or to any of the examples described herein, wherein the machine-readable instructions further comprise instructions to forward information on the request to a secure arbitration module (244) for processing the request based on microcode related to the request.

Another example (e.g., example 5) relates to a previously described example (e.g., one of the examples 1 to 4) or to any of the examples described herein, wherein the machine-readable instructions further comprise instructions to receive information on the failure report from the secure arbitration module (244).

Another example (e.g., example 6) relates to a previously described example (e.g., one of the examples 1 to 5) or to any of the examples described herein, wherein the information on the failure report related to the component comprises information on a circuit-level failure affecting the component.

Another example (e.g., example 7) relates to a previously described example (e.g., one of the examples 1 to 6) or to any of the examples described herein, wherein the information on the failure report related to the component is based on a failure related to the component occurring in the field.

Another example (e.g., example 8) relates to a previously described example (e.g., one of the examples 1 to 7) or to any of the examples described herein, wherein the machine-readable instructions comprise instructions to obtain the information on the failure report related to the component of the processing device from an in-field scan circuitry of the processing device.

Another example (e.g., example 9) relates to a previously described example (e.g., one of the examples 1 to 8) or to any of the examples described herein, wherein the machine-readable instructions comprise instructions to obtain the information on the failure report related to the component after an interrupt being raised by a trusted domain in-field scan circuitry of the processing device.

Another example (e.g., example 10) relates to a previously described example (e.g., one of the examples 1 to 9) or to any of the examples described herein, wherein the machine-readable instructions comprise instructions to determine the information on the microcode update to be applied to the processing device to remedy the failure related to the component based on a mapping between failures and microcode updates.

Another example (e.g., example 11) relates to a previously described example (e.g., one of the examples 1 to 10) or to any of the examples described herein, wherein the machine-readable instructions comprise instructions to update the mapping between the failures and microcode updates.

Another example (e.g., example 12) relates to a previously described example (e.g., one of the examples 1 to 11) or to any of the examples described herein, wherein the mapping is an operator-defined policy supplied by an operator of a computer system comprising the processing device (105).

Another example (e.g., example 13) relates to a previously described example (e.g., one of the examples 1 to 12) or to any of the examples described herein, wherein the machine-readable instructions comprise instructions to obtain second information on a failure of a component of the processing device (105) occurring in other computer systems (100), to determine information on a microcode update to be applied to the processing device (105) to remedy the failure related to the component included in the second information, and to configure the processing device to apply the microcode update.

Another example (e.g., example 14) relates to a previously described example (e.g., one of the examples 1 to 13) or to any of the examples described herein, wherein the microcode update affects one or more elements of the group of an operating frequency of the component of the processing device (105), a use of one or more components of the processing device (105) for performing an instruction being exposed by an instruction set architecture of the processing device (105), instructions to emulate a functionality originally provided by the component, a shared use of one or more components of the processing device (105) in simultaneous multithreading, or instructions being exposed by an instruction set architecture of the processing device (105).

Another example (e.g., example 15) relates to a previously described example (e.g., one of the examples 1 to 14) or to any of the examples described herein, wherein the microcode update relates to one or more elements of the group of an input/output controller of the processing device (105), affecting the use of at least a part of an interface being coupled to the processing device, a memory controller of the processing device (105), affecting the use of at least a portion of memory included in a computer system comprising the processing device (105), or a storage controller of the processing device (105), affecting the use of at least a portion of storage circuitry included in a computer system comprising the processing device (105).

Another example (e.g., example 16) relates to a previously described example (e.g., one of the examples 1 to 15) or to any of the examples described herein, wherein the microcode update is configured to disable the component or portions of logic within the component.

Another example (e.g., example 17) relates to a previously described example (e.g., one of the examples 1 to 16) or to any of the examples described herein, wherein the processing device (105) is an XPU, the XPU being one of a Central Processing Unit (CPU), Graphics Processing Unit (GPU), an Artificial Intelligence (AI) accelerator, an accelerator card and offloading circuitry.

Another example (e.g., example 18) relates to a previously described example (e.g., one of the examples 1 to 17) or to any of the examples described herein, wherein the machine-readable instructions further include instructions to receive a request for monitoring a plurality of processing devices from the trusted domain, to authenticate the request, to obtain information on a plurality of failure reports related to a plurality of components of the plurality of processing devices, with a possible failure having occurred at runtime of the plurality of processing devices, and to provide the information on the plurality of failure reports in the trusted domain.

Another example (e.g., example 19) relates to a previously described example (e.g., one of the examples 1 to 8) or to any of the examples described herein, and is a computer system (100; 100a) comprising the apparatus (10; 10a) according to the above and the processing device (105).

Another example (e.g., example 20) relates to a previously described example (e.g., one of the examples 1 to 19) or to any of the examples described herein, wherein the apparatus (10; 10a) is implemented as part of a system firmware of the computer system (100; 100a).

Another example (e.g., example 21) relates to an apparatus (10; 10a) for monitoring a processing device (105) from an application in a trusted domain, the apparatus (10; 10a) comprising interface circuitry (12), machine-readable instructions, and processing circuitry (14) to execute the machine-readable instructions to transmit a request for monitoring the processing device (105) in the trusted domain and to receive information on a failure report about the processing device (105) in the trusted domain.

Another example (e.g., example 22) relates to a previously described example (e.g., example 23) or to any of the examples described herein, further comprising machine-readable instructions to transmit a request for monitoring a plurality of processing devices (105) in the trusted domain (112) and to receive information on a plurality of failure reports about the plurality of processing devices (105) in the trusted domain (112).

Another example (e.g., example 23) relates to a device (10; 10a) for monitoring a processing device (105) from a trusted domain (112), the device (10; 10a) comprising means for interfacing (12), machine-readable instructions, and means for processing (14) to execute the machine-readable instructions to receive a request for monitoring the processing device (105) from the trusted domain (112); authenticate the request; obtain information on a failure report related to a component of the processing device (105), with a possible failure having occurred at runtime of the processing device (105); and provide the information on the failure report in the trusted domain (112).

Another example (e.g., example 24) relates to a previously described example (e.g., example 23) or to any of the examples described herein, wherein the machine-readable instructions further comprise instructions to determine information on a microcode update to be applied to the processing device (105) to remedy a failure related to the component, and to configure the processing device (105) to apply the microcode update.

Another example (e.g., example 25) relates to a device (10; 10a) for monitoring a processing device (105) from an application in a trusted domain, the device (10; 10a) comprising means for interfacing (12), machine-readable instructions, and means for processing (14) to execute the machine-readable instructions to transmit a request for monitoring the processing device (105) in the trusted domain and to receive information on a failure report about the processing device (105) in the trusted domain.

Another example (e.g., example 26) relates to a previously described example (e.g., example 25) or to any of the examples described herein, further comprising machine-readable instructions to transmit a request for monitoring a plurality of processing devices (105) in the trusted domain (112) and to receive information on a plurality of failure reports about the plurality of processing devices (105) in the trusted domain (112).

Another example (e.g., example 27) relates to a previously described example (e.g., one of the examples 1 to 26) or to any of the examples described herein, and is a method for monitoring a processing device (105) from a trusted domain (112), the method comprising receiving (22) a request for monitoring the processing device (105) from the trusted domain (112);

authenticating (24) the request; obtaining (26) information on a failure report related to a component of the processing device (105), with a possible failure having occurred at runtime of the processing device (105); and providing (28) the information on the failure report in the trusted domain.

Another example (e.g., example 28) relates to a previously described example (e.g., example 27) or to any of the examples described herein, wherein the method further comprises determining information on a microcode update to be applied to the processing device to remedy a failure related to the component, and configuring the processing device to apply the microcode update.

Another example (e.g., example 29) relates to a previously described example (e.g., examples 27 or 28) or to any of the examples described herein, wherein the method further comprises decoding the request.

Another example (e.g., example 30) relates to a previously described example (e.g., examples 27 to 29) or to any of the examples described herein, wherein the method further comprises forwarding information on the request to a secure arbitration module for processing the request based on microcode related to the request.

Another example (e.g., example 31) relates to a previously described example (e.g., examples 27 to 30) or to any of the examples described herein, wherein the method further comprises receiving information on the failure report from the se-cure arbitration module.

Another example (e.g., example 32) relates to a method for monitoring a processing device (105) from an application in a trusted domain (112), the method comprising transmitting (32) a request for monitoring the processing device (105) in the trusted domain (112), and receiving (34) information on a failure report about the processing device (105) in the trusted domain (112).

Another example (e.g., example 33) relates to a previously described example (e.g., example 32) or to any of the examples described herein, wherein the method further comprises transmitting a request for monitoring a plurality of processing devices in the trusted domain and receiving information on a plurality of failure reports about the plurality of processing devices in the trusted domain.

Another example (e.g., example 34) relates to a previously described example (e.g., examples 1 to 33) or to any of the examples described herein, further comprising that the method is performed by a system firmware of the computer system.

An example (e.g., example 35) relates to a non-transitory machine-readable storage medium including program code, when executed, to cause a machine to perform the method of one of the examples described herein.

An example (e.g., example 36) relates to a computer program having a program code for performing the method of one of the examples described herein when the computer program is executed on a computer, a processor, or a programmable hardware component.

An example (e.g., example 37) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for monitoring a processing device from a trusted domain, the apparatus comprising interface circuitry, machine-readable instructions, and processing circuitry to execute the machine-readable instructions to:
receive a request for monitoring the processing device from the trusted domain;
authenticate the request;
obtain information on a failure report related to a component of the processing device, with a possible failure having occurred at runtime of the processing device;
provide the information on the failure report in the trusted domain.

2. The apparatus of claim 1, wherein the machine-readable instructions further comprise instructions to determine information on a microcode update to be applied to the processing device to remedy a failure related to the component, and to configure the processing device to apply the microcode update.

3. The apparatus according to claim 1, wherein the machine-readable instructions further comprise instructions to decode the request.

4. The apparatus according to claim 1, wherein the machine-readable instructions further comprise instructions to forward information on the request to a secure arbitration module for processing the request based on microcode related to the request.

5. The apparatus according to claim 4, wherein the machine-readable instructions further comprise instructions to receive information on the failure report from the secure arbitration module.

6. The apparatus according to claim 1, wherein the information on the failure report related to the component comprises information on a circuit-level failure affecting the component.

7. The apparatus according to claim 1, wherein the information on the failure report related to the component is based on a failure related to the component occurring in the field.

8. The apparatus according to claim 1, wherein the machine-readable instructions comprise instructions to obtain the information on the failure report related to the component of the processing device from an in-field scan circuitry of the processing device.

9. The apparatus according to claim 1, wherein the machine-readable instructions comprise instructions to obtain the information on the failure report related to the component after an interrupt being raised by a trusted domain in-field scan circuitry of the processing device.

10. The apparatus according to claim 2, wherein the machine-readable instructions comprise instructions to determine the information on the microcode update to be applied to the processing device to remedy the failure related to the component based on a mapping between failures and microcode updates.

11. The apparatus according to claim 10, wherein the machine-readable instructions comprise instructions to update the mapping between the failures and microcode updates.

12. The apparatus according to claim 10, wherein the mapping is an operator-defined policy supplied by an operator of a computer system comprising the processing device.

13. The apparatus according to claim 1, wherein the machine-readable instructions comprise instructions to obtain second information on a failure of a component of the processing device occurring in other computer systems, to determine information on a microcode update to be applied to the processing device to remedy the failure related to the component included in the second information, and to configure the processing device to apply the microcode update.

14. The apparatus according to claim 2, wherein the microcode update affects one or more elements of the group of
an operating frequency of the component of the processing device,
a use of one or more components of the processing device for performing an instruction being exposed by an instruction set architecture of the processing device,
instructions to emulate a functionality originally provided by the component,
a shared use of one or more components of the processing device in simultaneous multithreading, or
instructions being exposed by an instruction set architecture of the processing device.

15. The apparatus according to claim 2, wherein the microcode update relates to one or more elements of the group of
an input/output controller of the processing device, affecting the use of at least a part of an interface being coupled to the processing device,
a memory controller of the processing device, affecting the use of at least a portion of memory included in a computer system comprising the processing device, or
a storage controller of the processing device, affecting the use of at least a portion of storage circuitry included in a computer system comprising the processing device.

16. The apparatus according to claim 2, wherein the microcode update is configured to disable the component or portions of logic within the component.

17. The apparatus according to claim 1, wherein the processing device is an XPU, the XPU being one of a Central Processing Unit (CPU), Graphics Processing Unit (GPU), an Artificial Intelligence (AI) accelerator, an accelerator card and offloading circuitry.

18. The apparatus of claim 1, wherein the machine-readable instructions further include instructions to receive a request for monitoring a plurality of processing devices from the trusted domain, to authenticate the request, to obtain information on a plurality of failure reports related to a plurality of components of the plurality of processing devices, with a possible failure having occurred at runtime of the plurality of processing devices, and to provide the information on the plurality of failure reports in the trusted domain.

19. A computer system comprising the apparatus according to claim 1 and the processing device.

20. The computer system according to claim 19, wherein the apparatus is implemented as part of a system firmware of the computer system.

21. A method for monitoring a processing device from a trusted domain, the method comprising:
receiving a request for monitoring the processing device from the trusted domain;
authenticating the request;
obtaining information on a failure report related to a component of the processing device, with a possible failure having occurred at runtime of the processing device;
providing the information on the failure report in the trusted domain.

22. A non-transitory, computer-readable medium comprising a program code that, when the program code is executed on a processor, a computer, or a programmable hardware component, causes the processor, computer, or programmable hardware component to perform the method of claim 21.

23. A method for monitoring a processing device from an application in a trusted domain, the method comprising
transmitting a request for monitoring the processing device in the trusted domain; and
receiving information on a failure report about the processing device in the trusted domain.
